(19) United States
(12) Patent Application Publication
(10) Pub. No.: US 2008/0189081 A1
(43) Pub. Date: Aug. 7, 2008

(54) SYSTEM AND METHOD FOR ANALYZING GEOMETRIC DEVIATIONS OF A PHYSICAL OBJECT

(75) Inventors: CHIH-KUANG CHANG, Tu-Cheng (TW); XIAO-CHAO SUN, Shenzhen (CN); DONG-HAI LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/859,793

(22) Filed: Sep. 24, 2007

(30) Foreign Application Priority Data
Feb. 6, 2007 (CN) 200710200159.8

(51) Int. Cl. G06F 17/50

(52) U.S. Cl. 703/1

(57) ABSTRACT

An exemplary method for analyzing geometric deviations of a physical object is provided. The method includes: receiving point cloud data of a point cloud from a measuring machine which scans an physical object; receiving one or more parameters set by a user, the one or more parameters comprising a predetermined acceptable tolerance; fitting a least squares model based on the point cloud data according to a least squares method; analyzing the geometric deviations of the physical object based on the least squares model and obtaining an analysis result; performing a point cloud simulation by using Open Graphics Library based on the least squares model and the point cloud data; and generating a report based on the point cloud simulation and the analysis result. A related system is also provided.

### BACKGROUND OF THE INVENTION

1. Field of the Invention

The present invention generally relates to a system and method for analyzing geometric deviations of a physical object.

2. Description of Related Art

Maintaining and improving product quality keep an enterprise competitive. Therefore, it is essential to verify whether specifications of a manufactured prototype of a product satisfy predetermined requirements before mass production of the product. For an n-dimensional curved surface (“n” may be one, two or three), conventional measuring and testing methods use a particular equipment to manually measure and verity physical properties of the manufactured prototype to determine whether the manufactured prototype is acceptable.

Today, a computer can be found in a broad range of applications within the industry, where it can be used for such things as controlling the equipment to measure the physical object rapidly and obtain a plurality of discrete points commonly called point cloud. The point cloud can be inputted to the computer to form an electronic figure of the physical object. When analyzing and processing the point cloud data by executing particular software, the physical object is verified, and a data file is generated based on the analyzed and processed point cloud data. Conventional data files only show coordinates of points. The data file is not very visual, real position of each point may not be shown clearly and geometric deviations of the physical object need to be translated by a professional technician, a process that is hard for laypeople.

What is needed, therefore, is a system and a method for analyzing geometric deviations of a physical object, which can perform a point cloud simulation based on quantized data, making analysis of the geometric deviations more visualized and clearly.

### SUMMARY OF THE INVENTION

A system for analyzing geometric deviations of a physical object is provided. The system includes an application server and a plurality of application terminals. The application server includes a receiving module, a computing module, a simulating module and a saving module. The receiving module is configured for receiving point cloud data of a point cloud from a measuring machine which scans the physical object, and for receiving one or more parameters set by a user from one of the application terminals. The one or more parameters include a predetermined acceptable tolerance. The computing module is configured for fitting a least squares model based on the point cloud data according to a least squares method, analyzing the geometric deviations of the physical object by computing a deviating value of each point based on the point cloud data and by comparing the deviating value with the predetermined acceptable tolerance, and obtaining an analysis result. The simulating module is configured for performing a point cloud simulation by using Open Graphics Library based on the least squares model, the point cloud data, and the analysis result. The saving module is configured for saving the point cloud simulation, the deviating value of each point and the analysis result.

A computer-based method for analyzing geometric deviations of a physical object is provided. The method includes: receiving point cloud data of a point cloud from a measuring machine which scans an physical object; receiving one or more parameters set by a user, the one or more parameters comprising a predetermined acceptable tolerance; fitting a least squares model based on the point cloud data according to a least squares method; analyzing the geometric deviations of the physical object based on the least squares model and obtaining an analysis result; performing a point cloud simulation by using Open Graphics Library based on the least squares model and the point cloud data; and generating a report based on the point cloud simulation and the analysis result.

Other systems, methods, features, and advantages of the present invention will be or become apparent to one with skill in the art on examination of the following drawings and detailed description.

### BRIEF DESCRIPTION OF THE DRAWINGS

FIG. 1 is a schematic diagram illustrating hardware configuration of a system for analyzing geometric deviations of a physical object in accordance with a preferred embodiment.

FIG. 2 is a schematic diagram illustrating function modules of an application server of FIG. 1.

FIG. 3 is a flowchart illustrating a method for analyzing geometric deviations of the physical object in accordance with a preferred embodiment.

FIG. 4 is one step of FIG. 3 in detail, namely analyzing the geometric deviations and performing a point cloud simulation.

### DETAILED DESCRIPTION OF THE INVENTION

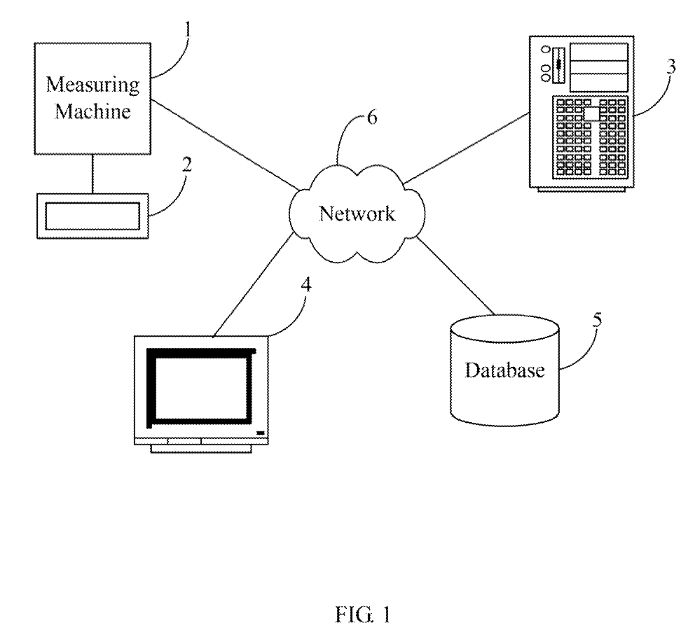

FIG. 1 is a schematic diagram illustrating hardware configuration of a system for analyzing geometric deviations of a physical object (hereinafter, “the system”), in accordance with a preferred embodiment. The system typically includes a measuring machine 1, at least one physical object 2 (only one shown in FIG. 1), an application server 3, a plurality of application terminals 4 (only one shown in FIG. 1), a database 5, and a network 6.

The measuring machine 1 is configured for scanning the physical object 2, and for obtaining a plurality of points (hereinafter “point cloud”) of the physical object 2 on a n-dimensional coordinate system. Each of the points includes n-dimensional coordinates data (hereinafter “point cloud data”) describing the point on the n-dimensional coordinate system (“n” may be one, two or three). The point cloud data are saved in a data file, such as a comma separated value (CSV) file, or a text (TXT) file. The database 5 is configured for storing the data file.

The application server 3 includes a plurality of function modules, and is configured for analyzing and computing geometric deviations of the point cloud data based on at least one analysis type, performing a point cloud simulation based on the point cloud data, and creating a point cloud animation according to the point cloud simulation. The at least one analysis type includes a flatness analysis, a parallelism analysis, a straightness analysis, a roundness analysis or a perpendicularity analysis.

The application terminals 4 are electronically connected with the application server 3, and may be located at various internal departments of an organization that implements the system. Each of the application terminals 4 provides a graphical interface for a user to set parameters for analyzing the point cloud, and for displaying the point cloud simulation and the point cloud animation. The parameters include the at least one analysis type, a predetermined acceptable tolerance, a point size, a first color to display correct points, a second color to display erroneous points, and so on.

The network 6 is an electronic network, which may be the Internet, an intranet, or any other suitable type of communications link.

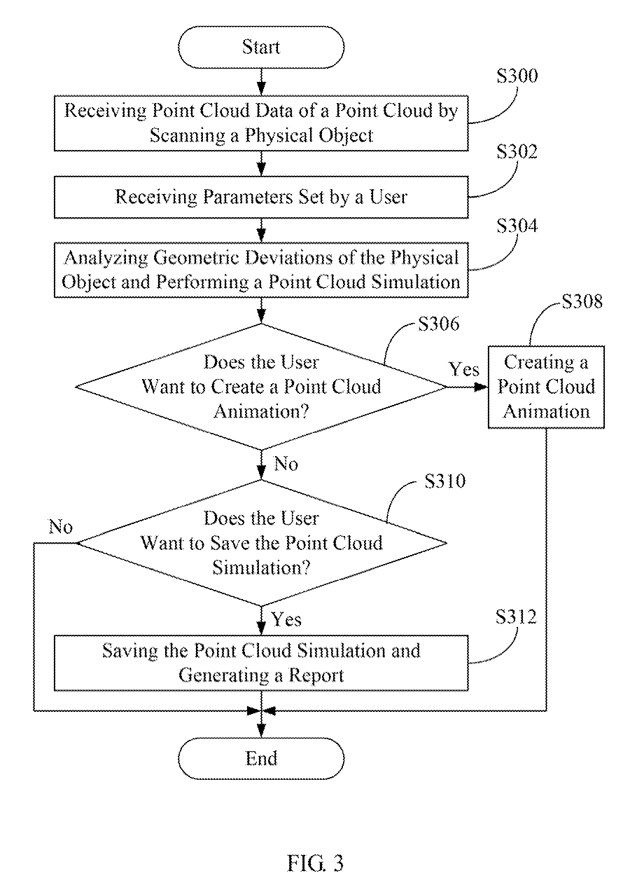

FIG. 2 is a schematic diagram illustrating function modules of the application server 3. The application server 3 mainly includes a receiving module 30, a computing module 31, a simulating module 33, a determining module 35, and a saving module 37.

The receiving module 30 is configured for receiving the point cloud data that may be from the data file stored in the database 5 or directly obtained from the measuring machine 1 by scanning the physical object 2. The receiving module 30 is also configured for receiving the parameters set from the application terminals 4. The determining module 35 detects whether the parameters are valid, namely detecting whether any one of the parameters meets a predetermined criteria correspondingly, and notifies the user when any one is not valid.

The computing module 31 is configured for fitting the point cloud of one of the application terminals 4 into a least squares model (i.e., a “best fit” model) according to a least squares method (also names a least squares technique), and finding a mathematical equation which best represents the least squares model. For example, the computing module 31 may fit the point cloud into a least squares plane by using the least squares method and find the mathematical equation which best represents the least squares plane. The computing module 31 analyzes the geometric deviations of the physical object 2 based on the analysis type and the least squares model by computing a deviating value of each point of the point cloud based on the point cloud data and the mathematical equation. For example, if the least squares model is the least squares plane, the computing module 31 may perform the flatness analysis, and compute a difference between each point from the least squares plane.

The least squares method is commonly used in curve fitting, and is a mathematical optimization technique that attempts to find the mathematical equation that closely approximates the coordinates data of the points in the point cloud.

The computing module 31 checks whether each of the deviating values equals zero. If any of the deviating values does not equal to zero, the computing module 31 determines that the corresponding point is an erroneous point that does not fit in the least squares model.

The computing module 31 also analyzes the geometric deviations of the physical object 2 to check whether the physical object 2 is acceptable by comparing the deviating value of each erroneous point with the predetermined acceptable tolerance, and obtains an analysis result.

Furthermore, the computing module 31 is further configured for computing the straightness of a least squares line, the roundness of a least squares circle or sphere, the flatness of the least squares plane, the parallelism of two parallel least squares rows, and the perpendicularity of a least squares vertical line or plane. For example, if the least squares model is the least squares plane, the computing module 31 may compute the flatness of the least squares plane.

The simulating module 33 is configured for performing the point cloud simulation by using OpenGL (Open Graphics Library) based on the least squares model, the point cloud data, and the point size. OpenGL is a low-level graphics library specification, which makes available to the user a small set of geometric primitives such as points, lines, polygons, images and bitmaps, and provides a set of commands that produce 3D computer graphics (and 2D computer graphics as well).

The simulating module 33 is further configured for displaying the point cloud simulation in the first color and the second color. The first color represents correct points that fit in the least squares model. The second color represents erroneous points that do not fit in the least squares model. In the preferred embodiment, the simulating module 33 also can display the point cloud simulation in a first color, a second color and a third color. For example, if the least squares model is the least squares plane, the first color represents correct points that fit in the least squares model, the second color represents the erroneous points which are above the least squares plane, and the third color represents the erroneous points which are below the least squares plane.

The determining module 35 is further configured for determining whether the user wants to save the point cloud simulation, and for determining whether the user wants to create a point cloud animation.

If the user wants to save the point cloud simulation, the saving module 37 saves the point cloud simulation in a suitable type file according to the user's requirement. For example, the saving module 37 can save the point cloud simulation in a “*.BMP” file, a “*.JPG” file or a “*.TIF” file. The saving module 37 is further configured for generating a report that can be printed. The report can be a CSV file or a TXT file, and includes the point cloud simulation, a maximum deviating value, the coordinate data of the point corresponding to the maximum deviating value, and the user's name.

Furthermore, the application server 3 may also include an animation creating module 39. If the determining module 37 determines the user wants to create the point cloud animation, the animation creating module 39 creates the point cloud animation based on the point cloud simulation to make the point cloud simulation come alive. The point cloud animation includes a series of motion pictures. The saving module 37 saves the point cloud animation in a suitable type file according to user's requirements such as an AVI (Audio/Video interleave) file.

In the preferred embodiment, the straightness analysis, the parallelism analysis, the straightness analysis and the perpendicularity analysis all obey the above method.

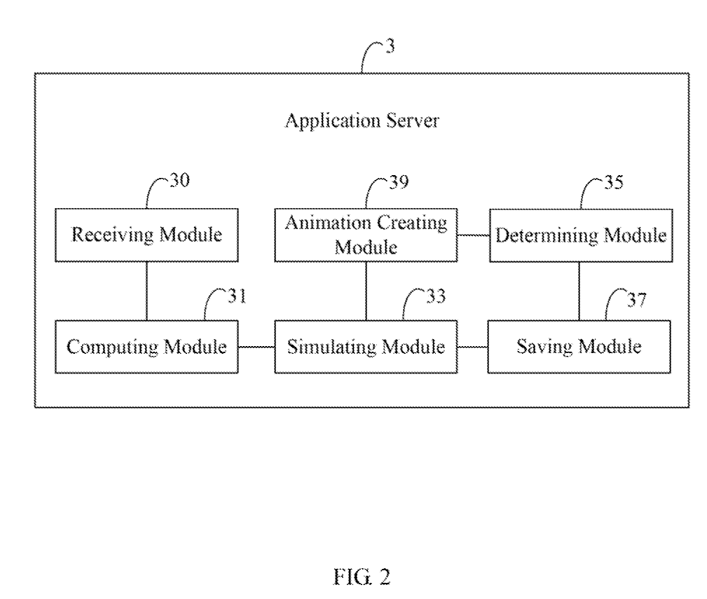

FIG. 3 is a flowchart illustrating a method for analyzing geometric deviations of the physical object 2 in accordance with a preferred embodiment.

In step S300, the receiving module 30 receives the point cloud data that may come from the database 5 or directly obtained from the measuring machine 1 which is presently scanning the physical object 2.

In step S302, the receiving module 30 receives parameters set by a user from each of the application terminals 4, and the determining module 35 detects whether any one of the parameters are valid and notifies the user when any one is not valid. The parameters include the at least one analysis type, the predetermined acceptable tolerance, the point size, the first color for displaying correct points, the second color for displaying erroneous points, and so on.

In step S304, the computing module 31 fits the point cloud data into the least squares model, analyzes the geometric deviations of the physical object 2 based on the least squares model and the analysis type and obtains the analysis result, and performs a point cloud simulation based on the least squares model, the analysis result, the point size, the first color and the second color set by the user.

In step S306, the determining module 35 determines whether the user wants to create a point cloud animation.

If the user wants to create the point cloud animation, in step S308, the animation creating module 39 creates the point cloud animation based on the point cloud simulation by making the point cloud simulation into the series of motion pictures. The saving module 37 can save the point cloud animation in an AVI file according to a user requirement.

If the user does not want to create the point cloud animation, in step S310, the determining module 34 inquires the user whether he/she want to save the point cloud simulation and determines the same according to a user's selection, and forward the determination to the saving module 37.

If the user wants to save the point cloud simulation, in step S312, upon receiving a positive determination, the saving module 37 saves the point cloud simulation into a suitable type file according to the user's requirements, and generates a report based on the point cloud simulation, the analysis result and the user's name. Otherwise, if the user does not want to save the point cloud simulation, the procedure ends. The report further includes a maximum deviating value, the coordinate data of the point corresponding to the maximum deviating value.

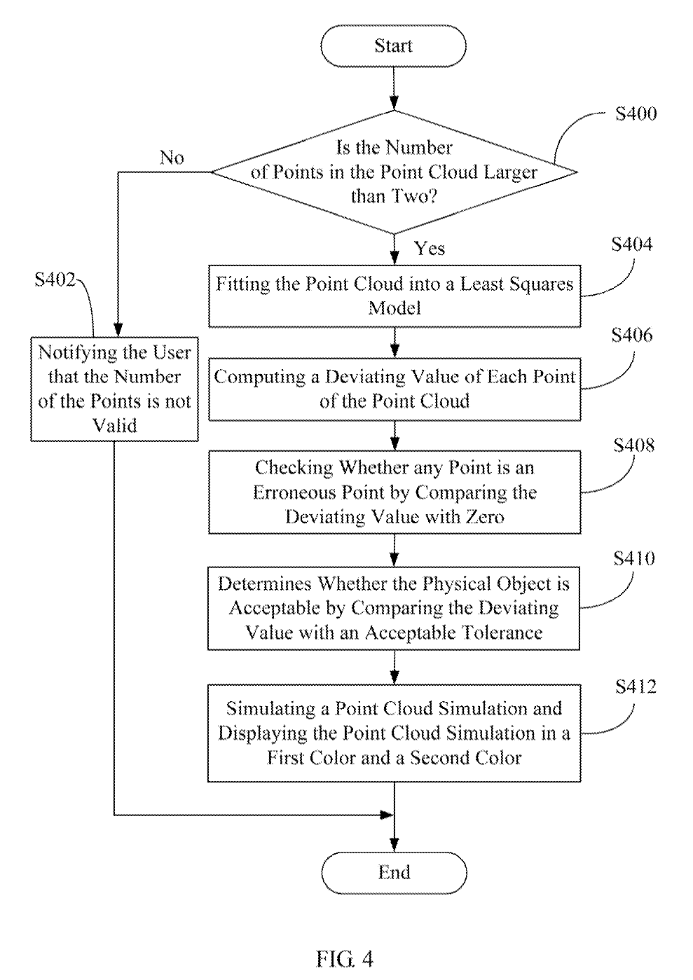

FIG. 4 is a flowchart of step S304 of FIG. 3 in detail, namely analyzing the geometric deviations and performing the point cloud simulation. In step S400, the determining module 35 detects whether the number of points in the point cloud is larger than two.

If the number of the points is not larger than two, in step S402, the determining module 35 notifies the user that the number of the points are received by the receiving module 30 is not valid.

If the number of the points is larger than two, in step S404, the computing module 31 fits the point cloud into the least squares model based on the least squares method and the point cloud data.

In step S406, the computing module 31 computes the deviating value of each point of the point cloud. For example, if the least squares model is the least squares line, the computing module 31 computes the deviating value of each point by computing a difference between each point from the least squares line.

In step S408, the computing module 31 checks whether any point of the point cloud is an erroneous point by comparing the deviating value of each point with zero. For example, if the deviating value of one point “a” is larger than zero, the computing module 31 determines that the point “a” is above the least squares model, and the point “a” would be considered as the erroneous point. If the deviating value of one point “b” is equal to zero, the computing module 31 determines that the point “b” is on the least squares model, and the point “b” is considered as the correct point. If the deviating value of one point “c” is less than zero, the computing module 31 determines that the point “c” is below the least squares model, and the point “c” would be considered as the erroneous point.

In step S410, the computing module 31 checks whether the physical object 2 is acceptable by comparing the deviating value with the predetermined acceptable tolerance. If the deviating value is larger than the predetermined acceptable tolerance, the physical object 2 is not acceptable. Otherwise, if the deviating value is not larger than the predetermined acceptable tolerance, the physical object 2 is acceptable.

In step S412, the simulating module 33 performs the point cloud simulation by using the OpenGL based on the least squares model, the point cloud data and the point size set by the user, and displays the point cloud simulation in the first color and the second color. The first color represents correct points that fit in the least squares model. The second color represents the erroneous points which so not fit in the least squares model.

In the preferred embodiment, the simulating module 33 can also display the point cloud simulation in the first color, the second color, and the third color. The first color represents the correct points that fit in the least squares model. The second color represents the erroneous points which are above the least squares plane. The third color represents the erroneous points which are below the least squares plane. For example, the simulating module 33 may display the point “b” that fit in the least squares model in green color, display the erroneous point “a” in red color, and display the erroneous point “c” in blue color. The simulating module 33 can also display the erroneous points in the other colors different from the green color.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for analyzing geometric deviations of a physical object, the system comprising an application server and a plurality of application terminals, the application server comprising:
a receiving module configured for receiving point cloud data of a point cloud from a measuring machine which scans the physical object, and for receiving one or more parameters set by a user from one of the application terminals, the one or more parameters comprising a predetermined acceptable tolerance;
a computing module configured for fitting a least squares model based on the point cloud data according to a least squares method, analyzing the geometric deviations of the physical object by computing a deviating value of each point based on the point cloud data and by comparing the deviating value with the predetermined acceptable tolerance, and obtaining an analysis result;
a simulating module configured for performing a point cloud simulation by using Open Graphics Library based on the least squares model, the point cloud data, and the analysis result; and
a saving module configured for saving the point cloud simulation, the deviating value of each point and the analysis result.

2. The system according to claim 1, wherein the computing module is further configured for checking whether any point of the point cloud is an erroneous point by comparing the deviating value of each point with zero.

3. The system according to claim 1, wherein the one or more parameters further comprise at least one analysis type, a color for displaying a particular set of points.

4. The system according to claim 3, wherein the application server further comprises a detecting module configured for detecting whether the one or more parameters are valid, and for notifying the user when any one of the parameters is not valid.

5. The system according to claim 3, wherein the at least one analysis type comprises a flatness analysis, a parallelism analysis, a straightness analysis, a roundness analysis and a perpendicularity analysis.

6. The system according to claim 3, wherein the color for displaying a particular set of points includes a first color for displaying correct points that fit in the least squares model and a second color for displaying erroneous points that do not fit in the least squares model.

7. The system according to claim 6, wherein the simulating module is further configured for displaying the point cloud simulation in the first color and the second color.

8. The system according to claim 1, wherein the point cloud data are received from a data file stored in a database, the data file comprising a comma separated value file or a text file.

9. The system according to claim 1, wherein the application server further comprises:
an animation creating module configured for creating a point cloud animation based on the point cloud simulation; and
a saving module configured for saving the point cloud simulation and the point cloud animation in suitable type files according to user's requirements.

10. A computer-based method for analyzing geometric deviations of a physical object, the method comprising:
receiving point cloud data of a point cloud from a measuring machine which scans an physical object;
receiving one or more parameters set by a user, the one or more parameters comprising a predetermined acceptable tolerance;
fitting a least squares model based on the point cloud data according to a least squares method;
analyzing the geometric deviations of the physical object based on the least squares model and obtaining an analysis result;
performing a point cloud simulation by using Open Graphics Library based on the least squares model and the point cloud data; and
generating a report based on the point cloud simulation and the analysis result.

11. The method according to claim 10, wherein the step of analyzing the geometric deviations of the physical object comprises steps of:
computing a deviating value of each point in the point cloud based on the point cloud data;
detecting whether the physical object is acceptable by comparing the deviating value with the predetermined acceptable tolerance;
indicating the physical object is acceptable if the deviating value is not larger than the predetermined acceptable tolerance; or
indicating the physical object is not acceptable if the deviating value is larger than the predetermined acceptable tolerance.

12. The method according to claim 10, further comprising:
detecting whether the one or more parameters set by the user are valid; and
notifying the user if any one of the parameter is not valid.

13. The method according to claim 10, wherein the one or more parameters further comprise at least one analysis type, a color for displaying a particular set of points.

14. The method according to claim 13, wherein the at least one analysis type comprises a flatness analysis, a parallelism analysis, a straightness analysis, a roundness analysis and a perpendicularity analysis.

15. The method according to claim 13, wherein the color for displaying a particular set of points includes a first color for displaying correct points that fit in the least squares model and a second color for displaying erroneous points that do not fit in the least squares model.

16. The method according to claim 15, further comprising steps of:
checking whether any point of the point cloud is an erroneous point by comparing the deviating value of each point with zero;
considering the point is correct point if the deviating value of the point is equal to zero, and displaying the correct point in the first color; or
considering the point is the erroneous point if the deviating value of the point is not equal to zero, and displaying the erroneous point in the second color.

17. The method according to claim 10, further comprising:
creating a point cloud animation based on the point cloud simulation; and
saving the point cloud simulation and the point cloud animation in suitable type files according to a user's requirements.
